(19) United States
(12) Patent Application Publication
(10) Pub. No.: US 2009/0179850 A1
(43) Pub. Date: Jul. 16, 2009

(54) Three-dimensional liquid crystal display device and related method of operation

(76) Inventors: Cheng-Yi Chen, Tainan (TW); Chung-Kuang Wei, Tainan (TW)

Correspondence Address: TROP, PRUNER & HU, P.C., 1616 S. VOSS ROAD, SUITE 750, HOUSTON, TX, 77057-2631, US

(21) Appl. No.: 12/317,408

(22) Filed: Dec. 23, 2008

(30) Foreign Application Priority Data
Jan. 11, 2008 (TW) 097101182

(51) Int. Cl. G09G 3/36; G06T 15/00

(52) U.S. Cl. 345/102; 345/419

(57) ABSTRACT

A three-dimensional liquid crystal display (LCD) system may adjust the luminance of a backlight source to prevent a user from seeing a residual image. A backlight source may provide a darker first luminance when the system is updating frames and a brighter second luminance when the three-dimensional LCD system is in a blanking period. Residual images problems are thus avoided and electricity may be conserved.

### CROSS-REFERENCE TO RELATED APPLICATION

Pursuant to 35 U.S.C. §119, this application claims priority to Taiwan Application Serial No. 097101182, filed Jan. 11, 2008, the subject matter of which is incorporated herein by reference.

### BACKGROUND

FIG. 1A is a schematic diagram of conventional three-dimensional display system 100. A user wears a pair of light-shielding glasses 120 (e.g., liquid crystal display (LCD) glasses or spectacles) while watching display 110. Display 110 alternately outputs signals for the user's left and right eyes while continuously illuminating a backlight source (not shown). Glasses 120 may include lenses, possibly mounted in frames, worn in front of the user's eyes to facilitate stereoscopic vision (i.e., three-dimensional viewing). The left eye lens of glasses 120 is open (i.e., turns on) and the right eye lens is closed (i.e., turns off) when display 110 displays signals for the left eye. Afterwards, the right eye lens is open and the left eye lens is closed when display 110 alternates to display signals for the right eye. After the left eye and right eye each receive their respective display signals, the user's mind generates a three-dimensional image based on principles of visual persistence. In other words, three-dimensional imaging principles hold that when different frames are supplied to the user's left and right eyes in an alternating fashion, allowing the eyes to potentially receive alternating different images, the user's brain will process the two-dimensional images to form three-dimensional images.

FIG. 1B is a timing diagram for an LCD device according to conventional three-dimensional display system 100 of FIG. 1A. A left-eye frame 1(L) of display 110 starts loading or updating while the left lens of glasses 120 is open. The left lens closes when left-eye frame 1(L) finishes updating. Display 110 then enters a vertical blanking period wherein display 110 continues displaying frame 1(L) and no lens is open. After the vertical blanking time, display 110 starts updating right-eye frame 2(R) and the right lens opens. After right-eye frame 2(R) finishes updating, the right lens closes and display 110 again enters a vertical blanking period while displaying right-eye frame 2(R) with no lens open.

FIG. 1C is a schematic diagram of a residual image according to conventional three-dimensional display system 100 of FIG. 1A where the LCD display is simultaneosly driven with both left and right eye data. The right lens is opened when display 110 starts updating or loading right-eye frame 2(R), even though frame 2(R) has not yet updated completely. Therefore, the user's right eye undesirably views an incomplete frame (i.e., residual image) including portions of the previous left-eye frame 1(L) and portions of the incompletely updated right-eye frame 2(R).

### BRIEF DESCRIPTION OF THE DRAWINGS

The accompanying drawings are included to provide a further understanding of various embodiments of the invention, and are incorporated in and constitute a part of this specification. The drawings illustrate embodiments of the invention and, together with the description, serve to explain the principles of the invention.

FIG. 1A is a schematic diagram of a conventional three-dimensional display system.

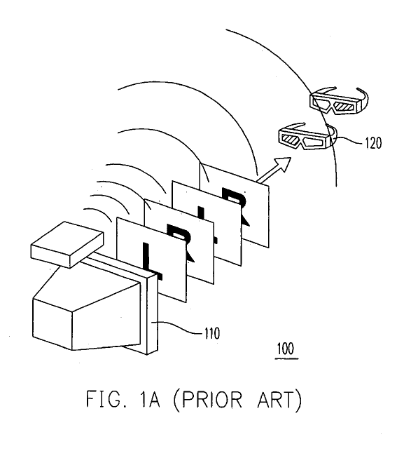

FIG. 1B is a timing diagram for an LCD device according to the conventional three-dimensional display system of FIG. 1A.

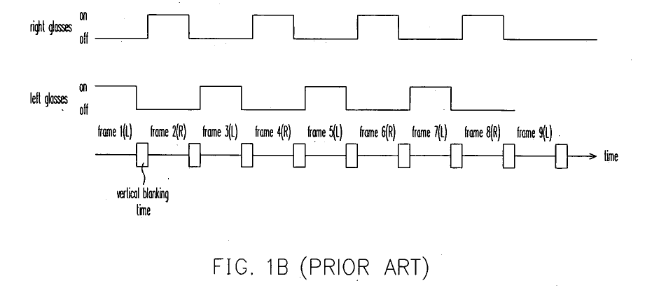

FIG. 1C is a schematic diagram of a residual image according to the conventional three-dimensional display system of FIG. 1A.

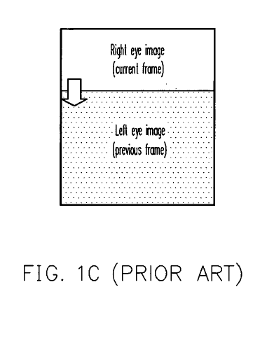

FIG. 2A is a schematic diagram of a three-dimensional LCD system according to an embodiment of the present invention.

FIG. 2B is a timing diagram according to the three-dimensional display system of FIG. 2A.

FIG. 3 is flow diagram according to a method for operating an LCD device in an embodiment of the invention.

### DESCRIPTION OF EMBODIMENTS

The following description refers to the accompanying drawings. Among the various drawings the same reference numbers may be used to identify the same or similar elements. While the following description provides a thorough understanding of various aspects of the claimed embodiments of the invention by setting forth specific details such as particular structures, architectures, interfaces, and techniques, such details are provided for purposes of explanation and should not be viewed as limiting. Moreover, those of skill in the art will, in light of the present disclosure, appreciate that various aspects of embodiments of the invention claimed may be practiced in other examples or implementations that depart from these specific details. At certain junctures in the following disclosure descriptions, well known devices, circuits, and methods have been omitted to avoid clouding the description of the present invention with unnecessary detail.

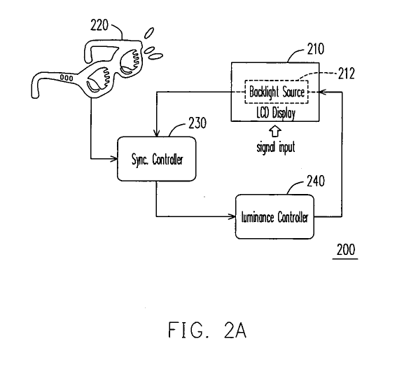

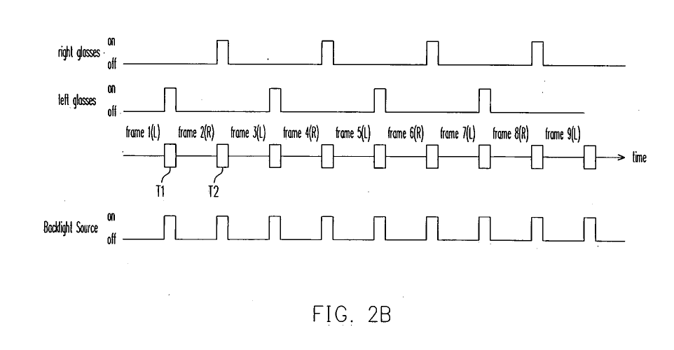

FIG. 2A is a schematic diagram of a three-dimensional liquid crystal display (LCD) system 200 according to an embodiment of the present invention. System 200 may include display 210 (e.g., a liquid crystal display (LCD)) and switch 220, which may be included in or coupled to a pair of light-shielding glasses (e.g., LCD glasses). LCD 210 may be any of various LCD types including, for example, a transmissive type LCD or transflective type LCD. LCD 210 may include a backlight source 212 electrically connected to switch 220. As will be explained more fully in the discussion concerning FIG. 2B, switch 220 may coordinate (e.g., synchronize) with backlight source 212 to produce a first luminance when LCD 210 updates frames. Switch 220 may also coordinate with backlight source 212 to produce a second luminance when LCD 210 is not updating frames (i.e., during a blanking period). The first luminance may be darker or lower (e.g., dimmed or extinguished entirely) than the second luminance (e.g., partially dimmed or fully illuminated). Consequently, system 200 may solve or partially solve residual image-related problems.

In another embodiment of the invention, system 200 may also include synchronous controller 230, which may be electrically connected to LCD 210 and switch 220. System 200 may also include luminance controller 240, which may be electrically connected to synchronous controller 230 and backlight source 212. Again, as will be explained more fully in the discussion concerning FIG. 2B, switch 220 may cooperate with luminance controller 240 and/or synchronous controller 230 to control luminance of backlight source 212.

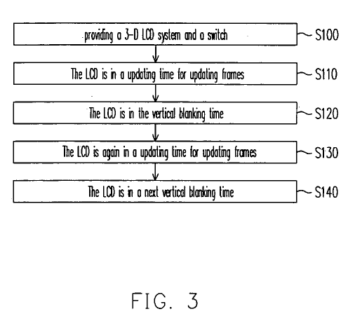

FIG. 2B is a timing diagram according to system 200 of FIG. 2A. FIG. 3 is flow diagram according to a method for operating an LCD device in an embodiment of the invention.

In step S100 (FIG. 3), system 200 and switch 220 (FIG. 2A) are provided.

In step S110, LCD 210 updates frames. For example, LCD 210 updates or processes frame 1(L) (FIG. 2B), which will eventually be provided to the left eye. During this updating period, LCD 210 may coordinate with backlight source 212 to provide a first luminance. The first luminance may constitute complete darkness because, for example, power to backlight source 212 may have been interrupted (e.g., deactivated).

In step S120, LCD 210 is in a blanking period. For example, after LCD 210 finishes processing frame 1(L) but before LCD 210 starts updating frame 2(R), which will eventually be provided to the right eye, there may be a vertical blanking period of time T1. During blanking period T1, LCD 210 may not update frames. Also during period T1, the user may view left eye frame 1(L) from LCD 210. For example, during first vertical blanking time T1 switch 220 may open the left-eye lens so the user's left eye can view frames of LCD 210. The left-eye lens may open simultaneously with the onset (i.e., leading edge) of period T1. However, in other embodiments of the invention, the left-eye lens may open during period T1 but after the onset period T1. Left-eye lens may even open before period T1 in some embodiments of the invention. Also, switch 220 may transmit a synchronous signal (i.e., “synch signal”) to luminance controller 240, via synchronous controller 230, to control backlight source 212 to have a second luminance. The signal to change luminance may occur simultaneously with the onset of period T1 or, in the alternative, during period T1 but after the onset of period T1. The signal to change luminance may occur before the onset of period T1 in some embodiments of the invention. The signal to change luminance may also be sent based on when a lens of the glasses opens or closes. For example, the luminance change may occur before the lens opens, simultaneous to when the lens opens, or after the lens opens. The second luminance may be brighter than the first luminance thereby allowing the left eye to see the frames. The second luminance may transition back to the first luminance based on when period T1 ends (e.g., simultaneous with, just before, or just after the offset or falling edge of T1). Thus, system 200 may drive LCD 210 with frame 1(L) data at the second luminance during the entirety of period T1, or a portion thereof.

In step S130, LCD 210 again updates frames. For example, LCD 210 may process (i.e., load, update) right-eye frame 2(R) signal while the left-eye lens is closed. Switch 220 may again control backlight source 212 to provide or output the first luminance. For example, switch 220 may terminate power to backlight source 212 when LCD 210 is updating frames.

In step S140, LCD 210 is again in a blanking period. For example, after right-eye frame 2(R) finishes updating, LCD 210 may enter a second vertical blanking time T2 and LCD 210 may display updated right-eye frame 2(R). Switch 220 may correspondingly open the right-eye lens and simultaneously transmit a synchronous signal to luminance controller 240 to control backlight source 212 to provide the second luminance. Specifically, switch 220 may provide power to backlight source 212 and/or adjust the luminance of backlight source 212 to a brighter level when LCD 210 is in second vertical blanking time T2. Hence, the user's right eye can view the frames of LCD 210.

Thereafter, LCD 210 may repeat steps S110-S140, in which frame signals provided to the left eye and the right eye are alternately processed, and switch 220 makes backlight source 212 alternately provide the first luminance or the second luminance corresponding to frame-updating times and vertical blanking times.

As explained in conjunction with the above steps, different embodiments of the invention may use different timing interrelationships between, for example, the opening/closing of a lens, the changing of illumination intensity to a backlight source, the updating of frame data, and the onset, offset, or any period between the onset and offset of a blanking period.

In one embodiment of the invention, when LCD 210 is updating or loading initial frame 1(L) data (i.e., an initial frame has not yet been displayed), switch 220 may open the left-eye lens even though frame 1(L) is not fully loaded. This sequence of operation may prevent switch 220 from failing to synchronize with backlight source 212. Also, since the first luminance may be complete darkness and the frames are updated at a very fast speed, the user may not see the temporary black frame.

In addition to resolving or lessening residual image problems, embodiments of the invention may also result in significant energy savings since backlight source 212 may be dimmed or extinguished for periods of time as frames are updated. In contrast, conventional backlight sources may continuously operate.

LCD 210 may be a transmissive type LCD in an embodiment of the invention. Thus, if power to backlight source 212 is interrupted, LCD 210 cannot display images. However, LCD 210 may also be a transflective type LCD in another embodiment of the invention. Although power to backlight source 212 may be interrupted, LCD 210 may still display images by reflection of an outside light source. Still, the outside light source may not provide sufficient luminance for LCD 210 to display the entire frame. Consequently, the image viewed by the user is darker and he or she may be unable to perceive any residual image.

In some embodiments of the invention, power to backlight source 212 may not be interrupted entirely when frames are updated. Instead, the first luminance of backlight source 212 may be adjusted to be relatively darker, when the frames are updated, as compared to the second luminance employed during a blanking period. Nevertheless, electricity consumed by backlight source 212 during, for example, a long on-state period would still be saved and potentially used when LCD 210 enters vertical blanking time T1. Also, this mode of operation (as well as fully interrupting power to the backlight source) may temporarily enhance the overall luminance of backlight source 212. In other words, the contrast ratio of the first luminance to the second luminance of backlight source 212 may be relatively elevated.

According to another embodiment of the invention, backlight source 212 may have three or more different luminances to avoid residual image problems. For example, backlight source 212 may provide a first luminance (e.g., little to no luminance) during frame updating. When a left-eye frame is completely loaded, backlight source 212 may provide a second luminance. When a right-eye frame is completely loaded, backlight source 212 may then provide a third luminance. The first, second, and third luminances may be different, and the second and third luminances may both be brighter than the first luminance.

In summary, a three-dimensional LCD system may adjust the luminance of a backlight source of a LCD to prevent showing a user a residual image. A backlight source may provide a darker first luminance, when the system is updating frames, and a brighter second luminance when the system is not updating frames. Consequently, residual image-related problems are avoided or lessened resulting in clearer and more accurate imaging of three-dimensional frames. Additionally, electricity may be conserved by temporarily terminating or lowering power to the backlight source.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of operating a liquid crystal display (LCD) device, comprising:
during a non-blanking period, driving the LCD device with left-eye frame data and right-eye frame data and controlling a related backlight source to output a first illumination level; and
during a blanking period, driving the LCD device with left-eye frame data but no right-eye-frame data and controlling the backlight source to output a second illumination level;
wherein the first illumination level is dimmer than the second illumination level.

2. The method of claim 1, wherein controlling the backlight source to output the first illumination level includes interrupting power to the backlight source.

3. The method of claim 1, further comprising initially controlling the backlight source to output the second illumination level simultaneously with the onset of the blanking period.

4. The method of claim 3, further comprising opening a left-eye lens included in stereoscopic spectacles based on the blanking period.

5. The method of claim 1, further comprising opening a left-eye lens included in stereoscopic spectacles during the blanking period.

6. The method of claim 5, further comprising initially opening the left-eye lens simultaneously with the onset of the blanking period.

7. The method of claim 1, further comprising:
during another blanking period, driving the LCD device with right-eye frame data but no left-eye frame data and controlling the backlight source to output a third illumination level;
wherein the first, second, and third illumination levels are unequal with each other.

8. A liquid crystal display (LCD) device comprising:
a controller to, during a first period, drive the LCD device with a residual image including first-eye frame data and second-eye frame data and control a related backlight source to output a first illumination level; and, during a second period, drive the LCD device with a non-residual image including no second-eye frame data and control the backlight source to output a second illumination level;
wherein the first illumination level is dimmer than the second illumination level.

9. The apparatus of claim 8, wherein the controller is to discontinue supplying power to the backlight source when controlling the backlight source to output the first illumination level.

10. The apparatus of claim 8, wherein the controller is to initially control the backlight source to output the second illumination level simultaneously with the onset of the second period.

11. The apparatus of claim 10, further comprising a switch to open a first-eye lens included in stereoscopic spectacles based on the second period.

12. The apparatus of claim 8, further comprising a switch to open a first-eye lens included in stereoscopic spectacles during the second period.

13. The apparatus of claim 12, wherein the switch is to initially open the first-eye lens simultaneously with the onset of the second period.

14. The apparatus of claim 8, wherein the controller is to, during a third period, drive the LCD device with another non-residual image including second-eye frame data but no first-eye frame data and control the backlight source to output a third illumination level, the first, second, and third illumination levels being unequal to one another.

15. A liquid crystal display (LCD) device comprising:
a controller to, during a non-blanking period, update the LCD device with left-eye frame data but no right-eye frame data and control a related backlight source to output a first illumination level; and, during a blanking period, drive the LCD device with left-eye frame data but no right-eye frame data and control the backlight source to output a second illumination level;
wherein the first illumination level is dimmer than the second illumination level.

16. The apparatus of claim 15, wherein the controller is to discontinue supplying power to the backlight source when controlling the backlight source to output the first illumination level.

17. The apparatus of claim 15, wherein the controller is to initially control the backlight source to output the second illumination level simultaneously with the onset of the blanking period.

18. The apparatus of claim 17, further comprising a switch to open a left-eye lens included in stereoscopic spectacles based on the blanking period.

19. The apparatus of claim 15, further comprising a switch to open a left-eye lens included in stereoscopic spectacles during the blanking period.

20. The apparatus of claim 19, wherein the switch is to initially open the left-eye lens simultaneously with the onset of the blanking period.
